(19) United States
(12) Patent Application Publication
(10) Pub. No.: US 2026/0189436 A1
(43) Pub. Date: Jul. 2, 2026

(54) METHOD AND APPARATUS FOR ESTIMATING CHANNEL IN WIRELESS COMMUNICATION SYSTEM

(71) Applicants: SAMSUNG ELECTRONICS CO., LTD., Suwon-si (KR); POSTECH Research and Business Development Foundation, Pohang-si (KR)

(72) Inventors: Ikbeom LEE, Suwon-si (KR); Yoseb JEON, Pohang-si (KR); Yujin KANG, Pohang-si (KR); Hayoung YANG, Suwon-si (KR); Kyeongcheol YANG, Pohang-si (KR); Sungyoung HA, Pohang-si (KR)

(73) Assignees: SAMSUNG ELECTRONICS CO., LTD., Suwon-si (KR); POSTECH Research and Business Development Foundation, Pohang-si (KR)

(21) Appl. No.: 19/540,179

(22) Filed: Feb. 13, 2026

Related U.S. Application Data
(63) Continuation of application No. PCT/KR2024/005252, filed on Apr. 18, 2024.

(30) Foreign Application Priority Data
Aug. 14, 2023 (KR) 10-2023-0106400
Sep. 26, 2023 (KR) 10-2023-0129296

(51) Int. Cl. H04L 25/02; H04L 5/00

(52) U.S. Cl. CPC H04L 25/0224; H04L 5/0048

(57) ABSTRACT

A method performed by a receiver in a wireless communication system, includes: determining a first channel estimation value, based on a demodulation reference signal (DM-RS) symbol in a resource block; detecting a first data symbol, based on the first channel estimation value; determining whether to obtain a second channel estimation value, based on the first data symbol; in a case that the second channel estimation value is obtained, detecting a second data symbol, based on the second channel estimation value; and performing channel decoding on the second data symbol.

### CROSS-REFERENCE TO RELATED APPLICATIONS

This application is a by-pass continuation application of International Application No. PCT/KR2024/005252, filed on Apr. 18, 2024, which is based on and claims priority to Korean Patent Application No. 10-2023-0106400, filed on Aug. 14, 2023, and Korean Patent Application No. 10-2023-0129296, filed on Sep. 26, 2023, in the Ministry of Intellectual Property, the disclosures of which are incorporated by reference herein their entireties.

### BACKGROUND

### 1. Field

The disclosure relates to a wireless communication system and, more specifically, to a method and an apparatus for estimating a channel in a wireless communication system.

### 2. Description of Related Art

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mm Wave such as 28 GHz and 39 GHz. In addition, 6G mobile communication technologies (referred to as Beyond 5G systems) are studied to be implemented in terahertz bands (e.g., 95 GHz to 3 THz bands) to accomplish transmission rates fifty times faster than 5G mobile communication technologies and ultra-low latency one-tenth of 5G mobile communication technologies.

At the beginning of 5G mobile communication technologies, to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks. Then, enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

According to an aspect of the present disclosure, a method performed by a receiver in a wireless communication system, includes: determining a first channel estimation value, based on a demodulation reference signal (DM-RS) symbol in a resource block; detecting a first data symbol, based on the first channel estimation value; determining whether to obtain a second channel estimation value, based on the first data symbol; in a case that the second channel estimation value is obtained, detecting a second data symbol, based on the second channel estimation value; and performing channel decoding on the second data symbol.

According to an aspect of the present disclosure, a receiver in a wireless communication system, the receiver comprising at least one processor configured to: determine a first channel estimation value, based on a demodulation reference signal (DM-RS) symbol in a resource block; detect a first data symbol, based on the first channel estimation value; determine whether to obtain a second channel estimation value, based on the first data symbol; in a case that the second channel estimation value is obtained, detect a second data symbol, based on the second channel estimation value; and perform channel decoding on the second data symbol.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a resource block according to an embodiment of the disclosure;

FIG. 2 illustrates a structure of a receiver in a wireless communication system according to an embodiment of the disclosure;

FIG. 3 illustrate an operation of estimating a channel by a receiver according to an embodiment of the disclosure;

FIG. 4 illustrate an operation of estimating a channel by a receiver according to an embodiment of the disclosure;

FIG. 5 illustrate an operation of estimating a channel by a receiver according to an embodiment of the disclosure;

FIG. 6 illustrate an operation of estimating a channel by a receiver according to an embodiment of the disclosure;

FIG. 7 illustrates a frame error rate versus a signal-to-noise ratio according to an embodiment of the disclosure; and

FIG. 8 illustrates a frame error rate versus a signal-to-noise ratio according to an embodiment of the disclosure.

With regard to the description of the drawings, the same or like reference signs may be used to designate the same or like elements.

### DETAILED DESCRIPTION

Various aspects of the claimed subject matter are now described with reference to the drawings, wherein like reference numerals are used to refer to like elements throughout. In the following description, for the purpose of explanation, numerous specific details are set forth in order to provide a full understanding of one or more embodiments. It may be apparent, however, that such aspect(s) may be practiced without these specific details.

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

In the following description, terms referring to signals (e.g., message, signal, signaling, sequence, and stream), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MAC CE), and radio access control (RRC) signaling), terms referring to network entities, terms referring to device elements, and the like are illustratively used for the sake of convenience. Therefore, the disclosure is not limited by the terms as described below, and other terms referring to subjects having equivalent technical meanings may be used.

Embodiments disclosed in the present disclosure describe an operation of estimating a channel of a receiver in a wireless communication system. For a detailed description of a receiver operation, a multiple-input multiple-output (MIMO) orthogonal frequency division multiplexing (OFDM) or multiple-input multiple-output orthogonal frequency division multiple access (OFDMA) communication system using Nₜ transmission antenna ports and Nᵣ reception antenna ports is assumed.

A multiple-input multiple-output (MIMO) communication system is a technology capable of significantly increasing a transmission speed and communication reliability of wireless communication, and is used as a core element technology of various wireless communication systems. In order to ensure high communication reliability in a MIMO communication system, a receiver needs to accurately obtain MIMO channel information. To this end, a conventional approach that has been widely applied is an RS-based channel estimation method using a demodulation reference signal (DM-RS). In this method, a transmitter transmits a DM-RS, which is already known to the receiver, using a portion of radio resources, and the receiver estimates a MIMO channel by using the DM-RS. In general, the accuracy of MIMO channel information obtainable through the RS-based channel estimation method increases as the amount of DM-RSs increases.

In the case of a MIMO-OFDM communication system using orthogonal frequency division multiplexing (OFDM) or orthogonal frequency division multiple access (OFDMA), accurate MIMO channel estimation needs to be performed for a time-frequency domain including multiple subcarriers and OFDM symbols. However, in a general MIMO-OFDM communication system, DM-RSs are allocated only to a limited number of subcarriers and OFDM symbols. In addition, increasing the amount of DM-RSs reduces resources available for data transmission, thereby decreasing data throughput, and thus arbitrarily increasing the amount of DM-RSs should be avoided. Accordingly, when a conventional RS-based channel estimation method is applied in a MIMO-OFDM communication system, there is a limitation in the accuracy of channel information that can be obtained by a receiver. In particular, when a channel varies significantly over a time-frequency domain, channel estimation accuracy of the RS-based channel estimation method is further reduced. Therefore, there is a need to develop a reception method and device capable of achieving high channel estimation performance in various channel environments in a MIMO-OFDM communication system having a limited amount of DM-RSs.

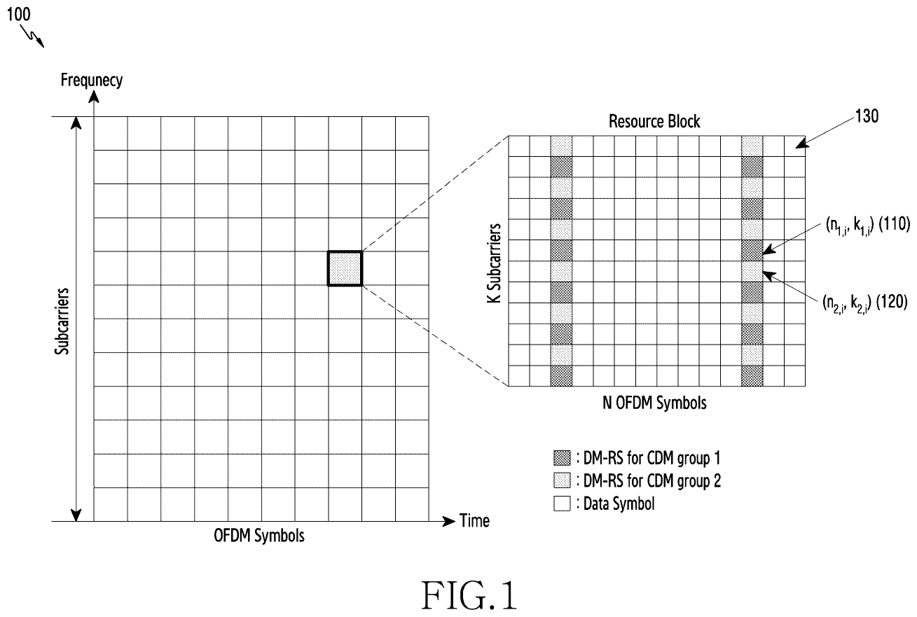

FIG. 1 illustrates a resource block 100 according to an embodiment of the disclosure. Specifically, FIG. 1 illustrates a resource block illustrating positions of DM-RSs received by a receiver.

Referring to FIG. 1, the resource block 100 includes K adjacent subcarriers and N adjacent OFDM symbols. Fixed values may be used for K and N constituting the resource block 100, and the resource block may also be a unit that is adaptively configured according to a time-domain correlation and a frequency-domain correlation of a channel. For example, the resource block may include 12 subcarriers and 14 OFDM symbols, where K=12 and N=14. In the disclosure, for a detailed description, a kth subcarrier of an nth OFDM symbol in the resource block is defined as a (n, k)th resource element (RE). Accordingly, each resource block is composed of N×K resource elements.

In the disclosure, a MIMO-OFDM system to which a code division multiplexing (CDM) scheme is applied as a signal multiplexing scheme is considered. In addition, in the disclosure, demodulation reference signals (DM-RSs), which are already known to the receiver, are transmitted through D resource elements among resource elements in the resource block, in order to estimate a channel of each CDM group. That is, DM-RSs for different antenna ports located on the same time-frequency resource may be distinguished by orthogonal codes.

Referring to FIG. 1, the resource block 100 may include CDM group 1 110 and CDM group 2 120 for DM-RSs. According to an embodiment of the disclosure, when the number of CDM groups is denoted by J, Nₜ transmission antenna ports may be assigned to one of J CDM groups. When code division multiplexing is applied to a resource block, a channel matrix of a (n, k)th resource element may be expressed as shown in Equation 1 below.

$$H [ n , k ] = [ {H}^{( 1 )} [ n , k ] , … , {H}^{( J )} [ n , k ] ] {ℂ}^{{N}_{r} \times {N}_{t}} \qquad [ Equation 1 ]$$

In Equation 1, H^{(j)}[n, k]∈ [symbol] denotes a channel matrix formed between transmission antenna ports belonging to a jth CDM group and Nᵣ reception antenna ports with respect to the (n, k)th resource element. According to an embodiment of the disclosure, an ith DM-RS transmitted for channel estimation of the jth CDM group is transmitted through a (n_{j,i}, k_{j,i})th resource element, and in this case, the transmitted DM-RS may be represented as t[n_{j,i}k_{j,i}]∈ [symbol] . In addition, among Nₜ elements of t[n_{j,i}, k_{j,i}], signals transmitted from transmission antenna ports not belonging to the jth CDM group may all have zero values.

According to an embodiment of the disclosure, a received signal y[n_{j,i}, k_{j,i}] detected (or observed) by the receiver in the (n_{j,i}, k_{j,i})th resource element may be represented as shown in Equation 2 below.

$$y [ {n}_{j , i} , {k}_{j , i} ] = H [ {n}_{j , i} , {k}_{j , i} ] t [ {n}_{j , i} , {k}_{j , i} ] + v [ {n}_{j , i} , {k}_{j , i} ] \qquad [ Equation 2 ]$$

In Equation 2, v[n, k]∈ [symbol] denotes a noise signal received in the (n, k)th resource element.

In the disclosure, data symbols are transmitted through resource elements in which DM-RSs are not transmitted among resource elements in a resource block. For example, in FIG. 1, among the resource elements in the resource block, a resource element 130 in which a DM-RS is not transmitted may correspond to a data symbol, and a transmitting end may transmit a signal for data to a receiving end on a data symbol. According to an embodiment of the disclosure, a data symbol transmitted through the (n, k)th resource element may be expressed as x[n, k]=[x₁[n, k], x₂ [n, k], . . . , x_{N}_{ₜ}[n, k]]^{T}∈A^{N}^{ₜ}. Here, A denotes a symbol constellation shared in advance between a transmitter and the receiver. A received signal y[n, k] detected (or observed) by the receiver through the (n, k)th resource element through which the data symbol is transmitted may be expressed as shown in Equation 3.

$$y [ n , k ] = H [ n , k ] x [ n , k ] + v [ n , k ] \qquad [ Equation 3 ]$$

In Equation 3, H[n, k]∈ [symbol] denotes a frequency-domain channel matrix formed for a kth subcarrier of an nth OFDM symbol, and v[n, k]∈ [symbol] denotes a noise signal observed at the kth subcarrier of the nth OFDM symbol.

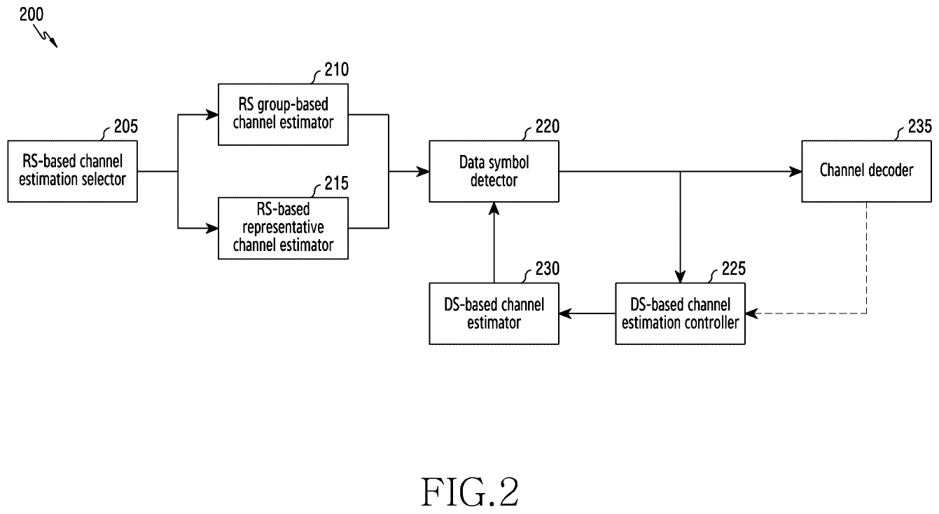

According to an embodiment of the disclosure, the receiver may estimate a channel, based on resource elements through which DM-RSs and data symbols are transmitted in the resource block of FIG. 1. A detailed operation in which the receiver estimates a channel will be described later with reference to FIG. 2.

FIG. 2 illustrates a structure 200 of a receiver in a wireless communication system according to an embodiment of the disclosure. In FIG. 2, operations of components within the receiver are applied in units of resource blocks of FIG. 1. However, the units of resource blocks in FIG. 1 may be freely defined depending on a system.

Referring to FIG. 2, the receiver may include an RS-based channel estimation selector 205, an RS group-based channel estimator 210, and an RS-based representative channel estimator 215 in order to estimate a channel based on DM-RSs. In addition, the receiver may include a data symbol detector 220, a DS-based channel estimation controller 225, and a data symbol-based channel estimator 230 in order to estimate a channel based on data symbols. Finally, the receiver may include a channel decoder 235 which recovers information bits based on detected data symbols.

According to an embodiment of the disclosure, when the receiver determines a channel estimation value by using DM-RSs received from multiple antenna ports, the RS-based channel estimation selector 205 included in the receiver may determine which channel estimation method is to be used. For example, the RS-based channel estimation selector 205 may determine whether to use a method for determining a channel estimation value by using the RS group-based channel estimator 210 or a method for determining a representative channel estimation value by using the RS-based representative channel estimator 215. Various channel estimation methods may be used as a method for determining a channel estimation value by using the RS group-based channel estimator 210 or the RS-based representative channel estimator 215. For example, a method for determining a channel estimation value for each DM-RS group by using the RS group-based channel estimator 210 may be represented as a first method. In addition, a method for determining a representative channel estimation value for all DM-RSs by using the RS-based representative channel estimator 215 may be represented as a second method.

In order to select a channel estimation method having the best performance, the RS-based channel estimation selector 205 may compare mean squared errors (MSEs) of channel estimation values obtained by the respective channel estimators 210 and 215, and select, as the channel estimation method, a method having a lower MSE from among a first method of determining a channel estimation value based on an RS group and a second method of determining a representative channel estimation value.

According to an embodiment of the disclosure, when the RS-based channel estimation selector 205 selects, as the channel estimation method, the first method of determining a channel estimation value by using the RS group-based channel estimator 210, an MSE of an RS group-based channel estimation method may be approximated as shown in Equation 4 below. Equation 4 may represent a value obtained by applying a least squares technique to group adjacent DM-RSs among DM-RSs into one group and estimate a channel of a resource element representative of the corresponding group.

$$E [ {‖ {H}^{( j )} [ n , k ] - {\hat{H}}_{R S}^{( j )} [ n , k ] ‖}_{F}^{2} ] \approx {\vert 1 - {\overline{ϵ}}_{c o n v} [ n , k ] \vert}^{2} ‖ {H}^{( j )} [ n , k ] {‖}_{F}^{2} + {N}_{r} {σ}^{2} Trace [ {( {{T}_{n , k}^{( j )} ( {T}_{n , k}^{( j )} )}^{H} )}^{- 1} ] \qquad [ Equation 4 ]$$

In Equation 4, ∈̅_{conv}[n, k] denotes an average value of time-frequency correlations between a channel of a (n, k)th resource element and channels through which DM-RSs used for estimating the channel of the resource element are transmitted, and σ² denotes a variance of a noise signal.

In addition,

$${‖ \cdot ‖}_{F}^{2}$$

denotes a squared Frobenius norm operation, and Trace(⋅) denotes a trace matrix operation.

According to an embodiment of the disclosure, when a channel estimation value is determined using the RS-based representative channel estimator 215, an MSE of the corresponding channel estimation method may be approximated as shown in Equation 5 below. Equation 5 may represent a value obtained by determining a channel estimate representative of the entire resource block by applying a least squares technique to simultaneously use all DM-RSs that are not adjacent in a time domain within a resource block for each CDM group.

$$E [ {‖ {H}^{( j )} [ n , k ] - {\hat{H}}_{R S}^{( j )} ‖}_{F}^{2} ] \approx {\vert 1 - {\overline{ϵ}}_{pro} [ n , k ] \vert}^{2} ‖ {H}^{( j )} [ n , k ] {‖}_{F}^{2} + {N}_{r} {σ}^{2} Trace [ {( {{T}_{RS}^{( j )} ( {T}_{RS}^{( j )} )}^{H} )}^{- 1} ] \qquad [ Equation 5 ]$$

In Equation 5, ∈̅ₚᵣₒ[n, k] denotes an average value of time-frequency correlations between a channel of a (n, k)th resource element and channels through which DM-RSs are transmitted.

The RS-based channel estimation selector 205 may compare MSE values calculated according to Equation 4 and Equation 5, and determine, as a DM-RS-based channel estimation method, a channel estimation method of a channel estimator having a lower MSE. According to an embodiment of the disclosure, when multiple CDM groups exist, the RS-based channel estimation selector 205 may determine an RS-based channel estimation method to be used separately for each CDM group.

According to another embodiment, the RS-based channel estimation selector may sum MSE values of all CDM groups and compare the summed MSE values, and then determine an RS-based channel estimation method to be commonly used by all CDM groups. In addition, in addition to a scheme of determining a channel estimation value of each channel estimator, the RS-based channel estimation selector 205 may also pre-determine an RS-based channel estimation method to be used by each CDM group by applying an external determination scheme.

When the RS-based channel estimation selector 205 determines to estimate a channel through the RS group-based channel estimator 210, the RS group-based channel estimator 210 may derive channel estimation values, based on DM-RSs received by the receiver from multiple antenna ports. According to an embodiment of the disclosure, the RS group-based channel estimator 210 may group DM-RSs into multiple groups, and calculate a channel estimation value for each group to determine the channel estimation value. For example, the RS group-based channel estimator 210 may consider a scheme of grouping adjacent DM-RSs on a radio resource grid among D DM-RSs into one group and estimating a channel of a resource element representative of the corresponding group. Assuming that a resource element representative of a specific DM-RS group is a (n, k)th resource element, a channel estimation value of the (n, k)th resource element, estimated using a least squares technique, may be expressed as shown in Equation 6 below.

$${\hat{H}}_{R S}^{( j )} [ n , k ] = {{Y}_{n , k}^{( j )} ( {T}_{n , k}^{( j )} )}^{H} {( {{T}_{n , k}^{( j )} ( {T}_{n , k ,}^{( j )} )}^{H} )}^{- 1} \qquad [ Equation 6 ]$$

In Equation 6,

$${T}_{n , k}^{( j )}$$

denotes a matrix having, as rows, DM-RSs used to estimate a channel of a (n, k)th resource element in a jth CDM group, and

$${Y}_{n , k}^{( j )}$$

denotes a matrix having, as rows, received signals corresponding to the DM-RSs used to estimate the channel of the (n, k)th resource element in the jth CDM group. In addition, (⋅)^{H} denotes a Hermitian operation, and (⋅)⁻¹ denotes an inverse matrix operation. The RS group-based channel estimator 210 may complete channel estimation of a resource element representative of each DM-RS group according to the above-described scheme, and then apply a linear interpolation technique to channel estimation values of DM-RS groups to determine channel estimation values for the remaining resource elements in the resource block.

In a case of using a method for estimating a channel of a representative resource element for each group by grouping adjacent DM-RSs among DM-RSs into one group, as in the RS group-based channel estimator 210, changes in channels formed differently for respective resource elements in the resource block may be reflected. However, the method may have a problem in that the number of DM-RSs belonging to each DM-RS group is limited, which may degrade the accuracy of channel estimation for each group.

When the channel estimation selector 205 determines to estimate a channel through the RS-based representative channel estimator 215, the RS-based representative channel estimator 215 may derive a representative channel estimation value considering all DM-RSs received by the receiver from multiple antenna ports. That is, the RS-based representative channel estimator 215 may determine channel estimation values representative of the entire resource block and derive the channel estimation values.

According to an embodiment of the disclosure, a method for estimating a channel by determining a representative channel estimation value by the RS-based representative channel estimator 215 may be a method for simultaneously using, for each CDM group, all DM-RSs that are not adjacent in a time domain within a resource block to determine a channel estimation value representative of the entire resource block. For example, in relation to a method for determining a representative channel estimation value by using a least square technique, a representative channel estimation value obtained in the jth CDM group may be expressed as shown in Equation 7 below.

$${\hat{H}}_{R S}^{( j )} = {{Y}_{R S}^{( j )} ( {T}_{R S}^{( j )} )}^{H} {( {{T}_{R S}^{( j )} ( {T}_{R S}^{( j )} )}^{H} )}^{- 1} \qquad [ Equation 7 ]$$

In Equation 7,

$${T}_{RS}^{( j )} = [ t [ {n}_{j , 1} , {k}_{j , 1} ] , … , t [ {n}_{j , D} , {k}_{j , D} ] ]$$

denotes a matrix having, as rows, all D DM-RSs transmitted for channel estimation of a j th CDM group, and

$${Y}_{RS}^{( j )} = [ y [ {n}_{j , 1} , {k}_{j , 1} ] , … , y [ {n}_{j , D} , {k}_{j , D} ] ]$$

denotes a matrix having, as rows, received signals for the corresponding DM-RSs. For another example, when the RS-based representative channel estimator 215 is able to obtain time-frequency correlation information of a channel, a representative channel estimation value obtained for the jth CDM group may be expressed as shown in Equation 8 below by applying a least squares technique using the correlation information.

$${\hat{H}}_{R S}^{( j )} = {{Y}_{R S}^{( j )} ( {T}_{R S}^{( j )} {E}_{R S}^{( j )} )}^{H} {( {T}_{R S}^{( j )} {{E}_{R S}^{( j )} ( {T}_{R S}^{( j )} {E}_{R S}^{( j )} )}^{H} )}^{- 1} \qquad [ Equation 8 ]$$

In Equation 8,

$${E}_{RS}^{( j )} = diag [ ϵ [ Δ {n}_{j , 1} , Δ {k}_{j , 1} ] , … , ϵ [ Δ {n}_{j , D} , Δ {k}_{j , D} ] ] , Δ {n}_{j , i} = {n}_{j , i} - {n}_{c} , and$$

$$Δ {k}_{j , i} = {k}_{j , i} - {k}_{c} and ϵ [ Δ n , Δ k ]$$

denotes a time-frequency correlation coefficient between a channel of a (n, k)th resource element and a channel of a (n+Δn, k+Δk)th resource element. In addition, n_{c} and k_{c} respectively denote an OFDM symbol position and a subcarrier position of a resource element located at the center of a resource block. When the RS-based representative channel estimator determines a representative channel estimation value to estimate a channel, the channel may be estimated by using or applying various estimation techniques other than a least squares technique. Thereafter, the RS-based representative channel estimator calculates a channel estimation value representative of the entire resource block, and then channel estimation values of all resource elements within the resource block may be configured to be the same as the representative channel estimation value. A method for estimating a channel by determining a representative channel estimation value by a receiver through the RS-based representative channel estimator 215 may accurately obtain a channel estimation value representative of a resource block by simultaneously using all DM-RSs available within the resource block.

With respect to resource elements through which data symbols are transmitted, the data symbol detector 220 may detect data symbols by using a reference signal-based channel estimation value according to one of the first method or the second method described above. The resource elements through which data symbols are transmitted may refer to, for example, resource elements in a resource block in which a DM-RS is not transmitted.

According to an embodiment of the disclosure, the data symbol detector 220 may detect a data symbol, based on a channel estimation value derived by a channel estimator selected by the RS-based channel estimation selector 205. A data symbol detected by the data symbol detector 220 based on a channel estimation value derived by the RS group-based channel estimator 210 or the RS-based representative channel estimator 215 may be referred to as a first data symbol. A channel estimation value for the (n, k)th resource element derived from a reference signal-based channel estimator selected according to a determination of a reference signal-based channel estimation selector may be expressed as shown in Equation 9. A channel estimation value expressed by Equation 9 may be, for example, a channel estimation value derived through the RS group-based channel estimator 210, or may also be a channel estimation value derived through the RS-based representative channel estimator 215.

$${\hat{H}}_{R S} [ n , k ] = [ {\hat{H}}_{R S}^{( 1 )} [ n , k ] , … , {\hat{H}}_{R S}^{( J )} [ n , k ] ] \qquad [ Equation 9 ]$$

In Equation 9, a data symbol detected by the data symbol detector 220 from a received signal y[n, k] of a (n, k)th resource element by using the channel estimation value of [Equation 9] may be represented as \hat{x}[n, k]∈A^{N}^{ₜ}. Various conventional MIMO symbol detection or MIMO data detection techniques may be used in a data symbol detection process. For example, when a maximum likelihood detection technique is used as a data symbol detection method, a data symbol (\hat{x}[n, k]) detected for the (n, k)th resource element may be expressed as shown in Equation 10.

$$\hat{x} [ n , k ] = {min}_{x ∈ {A}^{N} t} {‖ y [ n , k ] - \hat{H} [ n , k ] x ‖}^{2} \qquad [ Equation 10 ]$$

In Equation 10, Ĥ[n, k] denotes a channel estimation value for a (n, k)th resource element. The channel estimation value may refer to a channel estimation value determined by a reference signal-based channel estimator (e.g., 210 or 215) or a channel estimation value calculated by a data symbol-based channel estimator (e.g., 230).

For another example, when a linear minimum mean square error technique is used as a data symbol detection method, a data symbol (\hat{x}[n, k]) detected for the (n, k)th resource element may be expressed as shown in Equation 11 below.

$$\hat{x} [ n , k ] = {( {\hat{H}}^{H} [ n , k ] \hat{H} [ n , k ] + \frac{{σ}^{2}}{{σ}_{x}^{2}} {I}_{{N}_{r}} )}^{- 1} {\hat{H}}^{H} [ n , k ] y [ {n}_{i} , {k}_{i} ] \qquad [ Equation 11 ]$$

In Equation 11, I_{N}_{ᵣ}∈{0,1}^{N}^{ᵣ}^{×N}^{ᵣ} denotes a unit matrix, and

$${σ}_{x}^{2} = E [ {\vert {x}_{i} [ n , k ] \vert}^{2} ]$$

denotes a variance of each data symbol. When elements of a detected data symbol are not represented as one of elements of a symbol constellation, an additional process of mapping the detected elements to the nearest elements among the symbol constellation may be included.

According to an embodiment of the disclosure, the data symbol detector 220 may re-detect a data symbol according to a channel estimation value based on a data symbol derived by the DS-based channel estimator 230. The redetected data symbol may be, for example, referred to as a second data symbol. When the DS-based channel estimation controller 225 determines to activate the DS-based channel estimator 230, the DS-based channel estimator 230 may derive a channel estimation value by using a data symbol detected by the data symbol detector 220 according to a channel estimation value based on a DM-RS. In this case, the data symbol detector 220 may re-detect a data symbol based on the channel estimation value based on the data symbol derived by the DS-based channel estimator 230.

The DS-based channel estimation controller 225 may determine whether to activate the DS-based channel estimator 230 by using the data symbol detected by the data symbol detector 220. For example, the DS-based channel estimation controller 225 may determine an optimal sub-block size for the DS-based channel estimator 230, based on the data symbol, and determine whether to activate the DS-based channel estimator 230, based on the determined sub-block.

According to an embodiment of the disclosure, as a method for determining an optimal sub-block size, the DS-based channel estimation controller 225 may use a method for determining an optimal number of OFDM symbols (P*) and an optimal number of subcarriers (Q*) that minimize an MSE of a channel estimation value derivable by the DS channel estimator 230. For example, the DS-based channel estimation controller 225 may determine the sub-block through Equation 12.

$$( {P}^{★} , {Q}^{★} ) = {arg min}_{P , Q} {\vert 1 - {\overline{ϵ}}_{DS} [ n , k ] \vert}^{2} {‖ H [ n , k ] ‖}_{F}^{2} + {N}_{r} {σ}^{2} Trace [ {( {\hat{X}}_{i} {\hat{X}}_{i}^{H} )}^{- 1} ] \qquad [ Equation 12 ]$$

In Equation 12, ∈̅_{DS}[n, k] denotes an average value of time-frequency correlations between a channel of a (n, k)th resource element and channels of resource elements in a sub-block to which the corresponding channel belongs. After determining the optimal number of OFDM symbols (P*) and the optimal number of subcarriers (Q*) according to [Equation 12], an MSE of a channel estimation value derived by the DS-based channel estimator 230 may be calculated when the optimal sub-block size is used.

The DS-based channel estimation controller 225 may compare an MSE of the channel estimation method of the DS-based channel estimator 230 with an MSE of the DM-RS-based channel estimation method in order to determine whether to activate the DS-based channel estimator 230. According to an embodiment of the disclosure, when the MSE of the channel estimation method of the DS-based channel estimator 230 is lower than the MSE of the DM-RS-based channel estimation method, the DS-based channel estimation controller 225 may activate the DS-based channel estimator. In this case, since there is a high benefit in updating a channel estimation value based on DM-RSs to a channel estimation value obtained using the DS-based channel estimator 230, the DS-based channel estimation controller 225 may determine to activate the DS-based channel estimator. However, when the MSE of the channel estimation method of the DS-based channel estimator 230 is higher than the MSE of the DM-RS-based channel estimation method, the DS-based channel estimation controller 225 may deactivate the DS-based channel estimator 230. This is because, when the MSE of the channel estimation method of the DS-based channel estimator is higher than the MSE of the DM-RS-based channel estimation method, there is a low benefit in updating a channel estimation value based on DM-RSs to a channel estimation value obtained using the DS-based channel estimator. Meanwhile, an MSE of the RS-based channel estimation method, which is to be compared by the DS-based channel estimation controller, may refer to an MSE of the DM-RS-based channel estimation method selected by an RS-based channel selector. For example, the MSE of the RS-based channel estimation method may refer to the MSE selected by the RS-based channel selector among the MSEs of [Equation 4] and [Equation 5].

When the DS-based channel estimation controller 225 determines to activate the DS-based channel estimator 230, the DS-based channel estimator 230 may update a channel estimation value calculated by the RS group-based channel estimator 210 or the RS-based representative channel estimator 215. For example, the DS-based channel estimator 230 may divide a resource block into units of sub-blocks each including P OFDM symbols and Q subcarriers, and then use symbols detected for resource elements in each sub-block as virtual DM-RSs to determine a channel estimation value representative of channels of resource elements in the corresponding sub-block. In this case, a size of a sub-block may be a value determined by the DS-based channel estimation controller 225, or may be a predetermined fixed value.

According to an embodiment of the disclosure, a method in which the DS-based channel estimator 230 determines a channel estimation value, based on a data symbol detected by the data symbol detector 220, may have a difference in that the entire channel formed across all CDM groups is estimated at once, unlike a method for deriving a channel estimation value based on an RS, in which each CDM group individually estimates only a channel formed in its CDM group. A data symbol-based channel estimation value capable of representing an ith sub-block in the DS-based channel estimator 230 may be defined as Ĥ_{DS,i}∈ [symbol] . For example, when the DS-based channel estimator 230 determines a data symbol-based channel estimation value by using a least squares technique, an estimation value for a representative channel of the ith sub-block may be expressed as shown in Equation 13 below.

$${\hat{H}}_{DS , i} = {α}_{i} {Y}_{i} {{\hat{X}}_{i}^{H} ( {\hat{X}}_{i} {\hat{X}}_{i}^{H} )}^{- 1} \qquad [ Equation 13 ]$$

In Equation 13, Yᵢ∈ [symbol] denotes a matrix having, as rows, received signals observed in resource elements in an ith sub-block, \hat{X}ᵢ denotes a matrix having, as rows, transmitted DM-RSs or detected data symbols in resource elements in the ith sub-block, and αᵢ is a correction constant. Meanwhile, as an example for reducing the complexity of calculating a channel estimation value, the DS-based channel estimator 230 may calculate a channel estimation value by using an average received signal when multiple received signals corresponding to identical detected data symbols exist. For another example, when an average channel magnitude of the resource elements in the ith sub-block may be estimated through a separate process, the DS-based channel estimator 230 may determine a correction constant (αᵢ) such that a magnitude of a channel estimation value (Ĥ_{DS,i}) is corrected to match an estimated channel magnitude value. However, when the average channel magnitude of the resource elements in the ith sub-block cannot be estimated, it is also possible to set αᵢ=1.

After calculating a representative channel estimation value in the unit of a sub-block, channel estimation values of all resource elements in a sub-block may be configured to be the same as the representative channel estimation value.

The updated channel estimation values through the DS-based channel estimator 230 may be transferred to the data symbol detector 220. The data symbol detector 220 may re-detect data symbols in a resource block, based on the updated channel estimation values received from the DS-based channel estimator 230. The data symbol detector 220 may transmit the re-detected data symbols to the channel decoder 235. In this case, the re-detected data symbols may be referred to as second data symbols.

The channel decoder 235 may recover information bits, based on the data symbols detected through the data symbol detector 220. According to an embodiment of the disclosure, when the DS-based channel estimator 230 is deactivated, the channel decoder 235 may recover information bits, based on data symbols initially detected using channel estimation values based on RSs or log-likelihood ratio (LLR) values for the data symbols. On the other hand, when the DS-based channel estimator 230 is activated, the channel decoder 235 may recover information bits, based on re-detected data symbols based on data-symbol-based channel estimation values or LLR values for the re-detected data symbols.

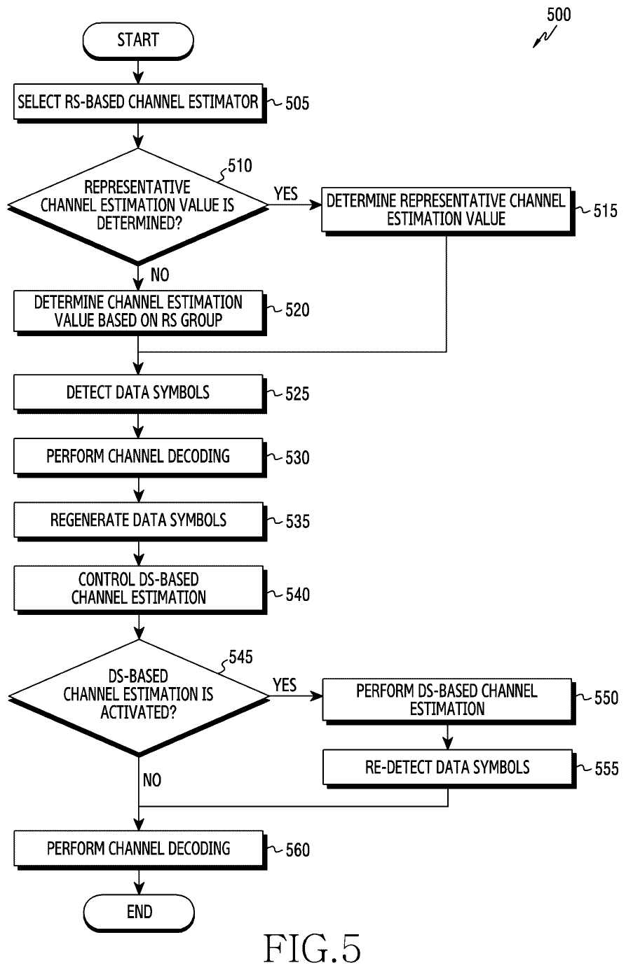

According to an embodiment of the disclosure, as a method for improving channel estimation performance of the DS-based channel estimator 230, data symbols may be regenerated (e.g., 535 of FIG. 5) based on information bits determined by the channel decoder 235, and the regenerated data symbols may be used as virtual demodulation reference signals to perform data symbol-based channel estimation. In this case, the regenerated data symbols may be referred to as third data symbols.

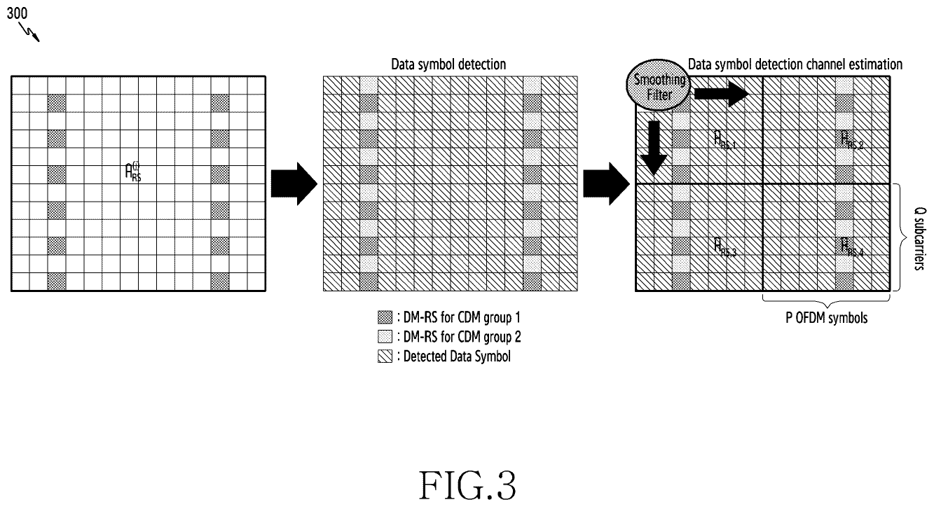

FIG. 3 illustrates an operation 300 in which a receiver estimates a channel according to an embodiment of the disclosure. Specifically, FIG. 3 illustrates an operation of estimating a channel based on a detected data symbol. In an embodiment, a channel estimation value derived based on RSs described in FIG. 3 is a channel estimation value derived through an RS-based representative channel estimator (e.g., 215 of FIG. 2).

Referring to FIG. 3, a receiver may determine a data symbol, based on a representative channel estimation value considering all DM-RSs in a resource block, by using a data symbol detector (e.g., 220 of FIG. 2). The representative channel estimation value considering all DM-RSs in the resource block may be a channel estimation value derived through an RS-based representative channel estimator (e.g., 215 of FIG. 2). The channel estimation value derived by the RS-based representative channel estimator may be, for example, a representative channel estimation value

$${\hat{H}}_{R S}^{( j )}$$

calculated in [Equation 6]. When the RS-based representative channel estimator is able to know time-frequency correlation information of a channel, the channel estimation value may be a representative channel estimation value

$${\hat{H}}_{R S}^{( j )}$$

calculated in [Equation 7]. With respect to resource elements through which data symbols are transmitted, the data symbol detector may detect data symbols by using a reference signal-based channel estimation value. The resource elements through which data symbols are transmitted may refer to, for example, resource elements in a resource block in which a DM-RS is not transmitted.

According to an embodiment of the disclosure, various conventional MIMO symbol detection or MIMO data detection techniques may be used in a data symbol detection process. For example, when a maximum likelihood detection technique is used as a data symbol detection method, a data symbol (\hat{x}[n, k]) detected for a (n, k)th resource element may be expressed as shown in [Equation 10] described with reference to FIG. 2. For another example, when a linear minimum mean square error technique is used as a data symbol detection method, a data symbol (\hat{x}[n, k]) detected for the (n, k)th resource element may be expressed as shown in [Equation 11] described with reference to FIG. 2.

ADS-based channel estimation controller (e.g., 225 of FIG. 2) may determine whether to activate a DS-based channel estimator (e.g., 230 of FIG. 2) by using a data symbol detected by the data symbol detector. For example, the DS-based channel estimation controller may determine an optimal sub-block size for the DS-based channel estimator, based on the data symbol, and determine whether to activate the DS-based channel estimator, based on the determined sub-block. According to an embodiment of the disclosure, as a method for determining the optimal sub-block size, the DS-based channel estimation controller may determine an optimal number of OFDM symbols P* and an optimal number of subcarriers Q* according to [Equation 12] described with reference to FIG. 2, and then calculate an MSE of a channel estimation value derived by the DS-based channel estimator when the optimal sub-block size is used.

The DS-based channel estimation controller may compare an MSE of a channel estimation method of the DS-based channel estimator with an MSE of a DM-RS-based channel estimation method in order to determine whether to activate the DS-based channel estimator. According to an embodiment of the disclosure, when the MSE of the channel estimation method of the DS-based channel estimator is lower than the MSE of the DM-RS-based channel estimation method, the DS-based channel estimation controller may activate the DS-based channel estimator. In this case, since there is a high benefit in updating a channel estimation value based on DM-RSs to a channel estimation value obtained using the DS-based channel estimator, the DS-based channel estimation controller may determine to activate the DS-based channel estimator. However, when the MSE of the channel estimation method of the DS-based channel estimator is higher than the MSE of the DM-RS-based channel estimation method, the DS-based channel estimation controller may deactivate the DS-based channel estimator. This is because, when the MSE of the channel estimation method of the DS-based channel estimator is higher than the MSE of the DM-RS-based channel estimation method, there is a low benefit in updating a channel estimation value based on DM-RSs to a channel estimation value obtained using the DS-based channel estimator. Meanwhile, an MSE of an RS-based channel estimation method, which is to be compared by the DS-based channel estimation controller, may refer to an MSE of the DM-RS-based channel estimation method selected by an RS-based channel selector. For example, the MSE of the RS-based channel estimation method may refer to the MSE selected by the RS-based channel selector among the MSEs of [Equation 4] and [Equation 5].

When the DS-based channel estimation controller determines to activate the DS-based channel estimator, the DS-based channel estimator may update a channel estimation value calculated by an RS-based channel estimator. For example, the DS-based channel estimator may divide a resource block into units of sub-blocks each including P OFDM symbols and Q subcarriers, and then use symbols detected for resource elements in each sub-block as virtual DM-RSs to determine a channel estimation value representative of channels of resource elements in the corresponding sub-block. In this case, values P and Q for determining a sub-block size may be values determined by the DS-based channel estimation controller, or may be predetermined fixed values.

According to an embodiment of the disclosure, a data symbol-based channel estimation value capable of representing an ith sub-block in the DS-based channel estimator may be defined as Ĥ_{DS,i}∈ [symbol] . For example, when the DS-based channel estimator determines a data symbol-based channel estimation value by using a least squares technique, an estimation value for a representative channel of the ith sub-block may be expressed as shown in [Equation 13] described with reference to FIG. 2.

As an example for reducing the complexity of calculating a channel estimation value, the DS-based channel estimator may calculate a channel estimation value by using an average received signal when multiple received signals corresponding to identical detected data symbols exist. For another example, when an average channel magnitude of resource elements in the ith sub-block may be estimated through a separate process, the DS-based channel estimator may determine a correction constant (αᵢ) such that a magnitude of a channel estimation value (Ĥ_{DS,i}) is corrected to match an estimated channel magnitude value. However, when an average channel magnitude of resource elements in the ith sub-block cannot be estimated, it is also possible to set αᵢ=1.

After calculating a representative channel estimation value for each sub-block unit, channel estimation values of all resource elements in a sub-block may be configured to be the same as the representative channel estimation value.

According to an embodiment of the disclosure, when the DS-based channel estimator uses a representative channel estimation value for each sub-block unit, a smoothing filter may be used to determine a channel estimation value in order to prevent degradation in performance of channel estimation values at boundaries of sub-blocks. When the smoothing filter is applied to channel estimation values in the entire resource block, a channel estimation value of each resource element may be replaced with a weighted average value of the channel estimation value of each resource element and channel estimation values of adjacent elements. A Gaussian filter may be used as a representative example of the smoothing filter, and one of various other smoothing filters may be used.

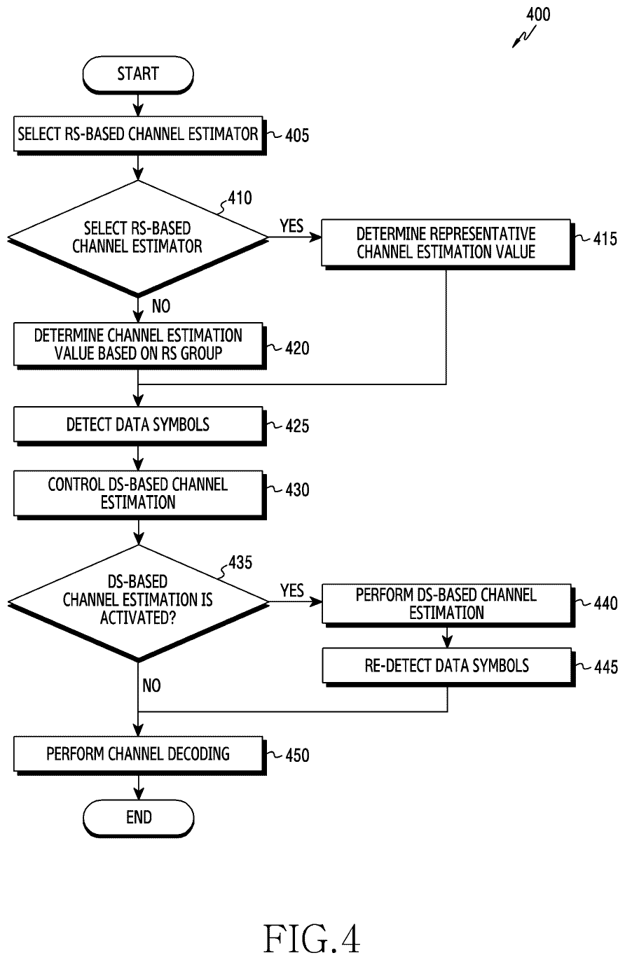

FIG. 4 illustrates an operation 400 in which a receiver estimates a channel according to an embodiment of the disclosure.

Referring to FIG. 4, in operation 405, a receiver may select one of an RS group-based channel estimation method and an RS-based representative channel estimation method for RS-based channel estimation. For example, the receiver may select a suitable channel estimator from among an RS group-based channel estimator (e.g., 210 of FIG. 2) and an RS-based representative channel estimator (e.g., 215 of FIG. 2) through an RS-based channel estimation selector (e.g., 205 of FIG. 2). According to an embodiment of the disclosure, in order to select a suitable channel estimator for RS-based channel estimation, the receiver may select a channel estimator that minimizes an MSE of a channel estimation value among a channel estimation value obtained through the RS group-based channel estimator and a channel estimation value obtained through the RS-based representative channel estimator.

In operation 410, the receiver may determine whether to obtain a representative channel estimation value capable of representing channels of resource elements in a resource block. That is, the receiver may determine whether the RS-based channel estimation selector in the receiver has selected the RS-based representative channel estimator as an estimator for deriving a DM-RS-based channel estimation value. When the RS-based channel estimation selector selects the RS-based representative channel estimator as the estimator for deriving a DM-RS-based channel estimation value, operation 415 may be performed. However, when the RS-based channel estimation selector selects the RS group-based channel estimator as the estimator for deriving a DM-RS-based channel estimation value, operation 420 may be performed.

In operation 415, the receiver may determine a representative channel estimation value capable of representing channels of resource elements in a resource block by using the RS-based representative channel estimator.

In operation 420, the receiver may determine channel estimation values of the resource elements in the resource block by using the RS group-based channel estimator. For example, the receiver may divide received DM-RSs into CDM groups by using the RS group-based channel estimator, derive a channel estimation value for each group, and then determine channel estimation values of resource elements for each group. However, a method for deriving a channel estimation value by an RS group-based channel estimator is not limited thereto, and various embodiments described above may be applied.

In operation 425, the receiver may determine data symbols for the corresponding resource block. Specifically, the receiver may determine data symbols through a data symbol detector (e.g., 220 of FIG. 2). For example, the receiver may determine data symbols, based on a channel estimation value estimated based on a DM-RS and received signals. In this case, the data symbols determined by the receiver may be referred to as first data symbols.

In operation 430, the receiver may determine an optimal sub-block size for a DS-based channel estimator through a DS-based channel estimation controller (e.g., 225 of FIG. 2) in the receiver, and determine whether to activate the DS-based channel estimator. Whether to activate the DS-based channel estimator may be determined by comparing an MSE of a channel estimation method of the DS-based channel estimator with an MSE of a DM-RS-based channel estimation method. For example, when the MSE of the channel estimation method of the DS-based channel estimator is lower than the MSE of the DM-RS-based channel estimation method, the DS-based channel estimation controller may activate the DS-based channel estimator. However, when the MSE of the channel estimation method of the DS-based channel estimator is higher than the MSE of the DM-RS-based channel estimation method, the DS-based channel estimation controller may deactivate the DS-based channel estimator.

In operation 435, the receiver may determine whether to activate a DS-based channel estimation method. For example, the receiver may determine whether to activate the DS-based channel estimator. When the DS-based channel estimation controller in the receiver determines to activate the DS-based channel estimator, operation 440 may be performed. However, when the DS-based channel estimation controller in the receiver determines to deactivate the DS-based channel estimator such that the DS-based channel estimator is not activated, operation 450 may be performed.

In operation 440, the receiver may determine a channel estimation value based on the data symbols detected in operation 425 by using the DS-based channel estimator in the receiver. When the DS-based channel estimation controller (e.g., 225 of FIG. 2) included in the receiver determines to activate the DS-based channel estimator (e.g., 230 of FIG. 2), the receiver may update a channel estimation value calculated by an RS-based channel estimator by using the DS-based channel estimator. For example, the receiver may divide the resource block into units of sub-blocks each including P OFDM symbols and Q subcarriers, and then use symbols detected for resource elements in each sub-block as virtual DM-RSs to determine a channel estimation value representative of channels of resource elements in the corresponding sub-block. In this case, the channel estimation value calculated by the RS-based channel estimator may refer to a DM-RS-based channel estimation value determined in operation 415 or operation 420. In addition, a sub-block size may be a value determined by the DS-based channel estimation controller or may be a value predetermined in advance.

According to an embodiment of the disclosure, in a method for determining a channel estimation value based on a detected data symbol by a receiver, when a least squares technique is used to determine a data symbol-based channel estimation value, an estimation value for a representative channel of an ith sub-block may be expressed as [Equation 13] described above.

According to an embodiment of the disclosure, the DM-RS-based channel estimation value determined in operation 415 or operation 420 may be updated to a data symbol-based channel estimation value determined using the DS-based channel estimator.

In operation 445, the receiver may re-determine data symbols, based on the data symbol-based channel estimation value determined in operation 440. For example, the data symbol detector in the receiver may update a channel estimation value derived by the RS-based channel estimator to a channel estimation value derived by the DS-based channel estimator, and re-detect data symbols based on the updated channel estimation value. In this case, the data symbols re-detected by the receiver may be referred to as second data symbols. Meanwhile, when the DS-based channel estimator is not activated, the DS-based channel estimator does not perform channel estimation, and thus re-detection of data symbols by the data symbol detector may not be performed.

In operation 450, the receiver may perform channel decoding on data symbols of the resource block, based on detected data symbols or LLR values of the data symbols by using a channel decoder (e.g., 235 of FIG. 2). The receiver may perform channel decoding to recover information bits. The detected data symbols may refer to, for example, data symbols re-detected by the data symbol detector based on a channel estimation value derived through the DS-based channel estimator when the DS-based channel estimator is activated. In addition, the detected data symbols may refer to data symbols detected by the data symbol detector based on a channel estimation value derived through the RS-based channel estimator when the DS-based channel estimator is deactivated. According to an embodiment of the disclosure, when the DS-based channel estimator is in a deactivated state, the receiver may perform channel decoding on data symbols detected by using the channel estimation value determined based on the DM-RS in operation 425.

FIG. 5 illustrates an operation 500 in which a receiver estimates a channel according to an embodiment of the disclosure. Operations 505 to 525 of FIG. 5 may correspond to operations 405 to 425 of FIG. 4.

Referring to FIG. 5, in operation 505, a receiver may select one of an RS group-based channel estimation method and an RS-based representative channel estimation method for RS-based channel estimation. For example, the receiver may select a suitable channel estimator from among an RS group-based channel estimator (e.g., 210 of FIG. 2) and an RS-based representative channel estimator (e.g., 215 of FIG. 2) through an RS-based channel estimation selector (e.g., 205 of FIG. 2). According to an embodiment of the disclosure, in order to select a suitable channel estimator for RS-based channel estimation, the receiver may select a channel estimator that minimizes an MSE of a channel estimation value among a channel estimation value obtained through the RS group-based channel estimator and a channel estimation value obtained through the RS-based representative channel estimator.

In operation 510, the receiver may determine whether to obtain a representative channel estimation value capable of representing channels of resource elements in a resource block. That is, the receiver may determine whether the RS-based channel estimation selector in the receiver has selected the RS-based representative channel estimator as an estimator for deriving a DM-RS-based channel estimation value. When the RS-based channel estimation selector selects the RS-based representative channel estimator as the estimator for deriving a DM-RS-based channel estimation value, operation 515 may be performed. However, when the RS-based channel estimation selector selects the RS group-based channel estimator as the estimator for deriving a DM-RS-based channel estimation value, operation 520 may be performed.

In operation 515, the receiver may determine a representative channel estimation value capable of representing channels of resource elements in a resource block by using the RS-based representative channel estimator.

In operation 520, the receiver may determine channel estimation values of the resource elements in the resource block by using the RS group-based channel estimator. For example, the receiver may divide received DM-RSs into CDM groups by using the RS group-based channel estimator, derive a channel estimation value for each group, and then determine channel estimation values of resource elements for each group. However, a method for deriving a channel estimation value by an RS group-based channel estimator is not limited thereto, and various embodiments described above may be applied.

In operation 525, the receiver may determine data symbols for the corresponding resource block. Specifically, the receiver may determine data symbols through a data symbol detector (e.g., 220 of FIG. 2). For example, the receiver may detect data symbols, based on a channel estimation value estimated based on a DM-RS and received signals. In this case, the data symbols determined by the receiver may be referred to as first data symbols.

In operation 530, the receiver may perform channel decoding, based on data symbols detected by the data symbol detector or LLR values of the detected data symbols. The receiver may perform channel decoding to recover information bits. The detected data symbols may refer to, for example, data symbols detected by the data symbol detector based on a channel estimation value derived through an RS-based channel estimator.

In operation 535, the receiver may regenerate data symbols, based on the information bits recovered by performing channel decoding in operation 530. The regenerated data symbols may be used by a DS-based channel estimation controller and a DS-based channel estimator. The operations of channel decoding and regenerating data symbols performed by the receiver in operations 530 to 535 may be optionally performed and may be omitted. The regenerated data symbols may be referred to as third data symbols.

In operation 540, the receiver may determine an optimal sub-block size for a DS-based channel estimator through a DS-based channel estimation controller (e.g., 225 of FIG. 2) in the receiver, and determine whether to activate the DS-based channel estimator. Whether to activate the DS-based channel estimator may be determined by comparing an MSE of a channel estimation method of the DS-based channel estimator with an MSE of a DM-RS-based channel estimation method. In this case, the MSE of the channel estimation value derived through the DS-based channel estimator may be a value calculated based on the regenerated data symbols in operation 535.

According to an embodiment of the disclosure, when the MSE of the channel estimation method of the DS-based channel estimator is lower than the MSE of the DM-RS-based channel estimation method, the DS-based channel estimation controller may activate the DS-based channel estimator. However, when the MSE of the channel estimation method of the DS-based channel estimator is higher than the MSE of the DM-RS-based channel estimation method, the DS-based channel estimation controller may deactivate the DS-based channel estimator.

In operation 545, the receiver may determine whether to activate a DS-based channel estimation method. For example, the receiver may determine whether to activate the DS-based channel estimator. When the DS-based channel estimation controller in the receiver determines to activate the DS-based channel estimator, operation 550 may be performed. However, when the DS-based channel estimation controller in the receiver determines to deactivate the DS-based channel estimator such that the DS-based channel estimator is not activated, operation 560 may be performed.

In operation 550, the receiver may determine a channel estimation value based on the data symbols regenerated in operation 535 by using the DS-based channel estimator in the receiver. When the DS-based channel estimation controller (e.g., 225 of FIG. 2) included in the receiver determines to activate the DS-based channel estimator (e.g., 230 of FIG. 2), the receiver may update a channel estimation value calculated by an RS-based channel estimator by using the DS-based channel estimator. For example, the receiver may divide the resource block into units of sub-blocks each including P OFDM symbols and Q subcarriers, and then use symbols detected for resource elements in each sub-block as virtual DM-RSs to determine a channel estimation value representative of channels of resource elements in the corresponding sub-block. In this case, the channel estimation value calculated by the RS-based channel estimator may refer to a DM-RS-based channel estimation value determined in operation 515 or operation 520. In addition, a sub-block size may be a value determined by the DS-based channel estimation controller or may be a value predetermined in advance.

In operation 555, the receiver may re-determine data symbols, based on the data symbol-based channel estimation value determined in operation 550. For example, the data symbol detector in the receiver may update a channel estimation value derived by the RS-based channel estimator to a channel estimation value derived by the DS-based channel estimator, and re-detect data symbols based on the updated channel estimation value. In this case, the data symbols re-detected by the receiver may be referred to as second data symbols. Meanwhile, when the DS-based channel estimator is not activated, the DS-based channel estimator does not perform channel estimation, and thus re-detection of data symbols by the data symbol detector may not be performed.

In operation 560, the receiver may perform channel decoding on data symbols of the resource block, based on detected data symbols or LLR values of the data symbols by using a channel decoder. The receiver may perform channel decoding to recover information bits. The detected data symbols may refer to, for example, data symbols re-detected by the data symbol detector based on a channel estimation value derived through the DS-based channel estimator when the DS-based channel estimator is activated. In addition, the detected data symbols may refer to data symbols detected by the data symbol detector based on a channel estimation value derived through the RS-based channel estimator when the DS-based channel estimator is deactivated. According to an embodiment of the disclosure, when the DS-based channel estimator is in a deactivated state, the receiver may perform channel decoding on data symbols detected by using the channel estimation value determined based on the DM-RS in operation 525.

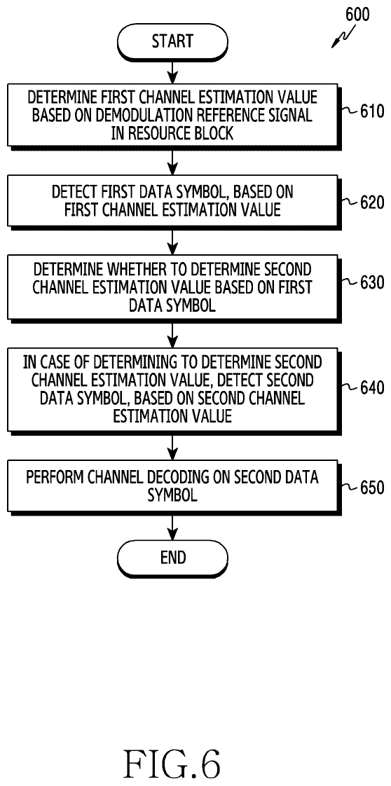

FIG. 6 illustrates an operation 600 in which a receiver estimates a channel according to an embodiment of the disclosure.

Referring to FIG. 6, in operation 610, a receiver may determine a first channel estimation value, based on a demodulation reference signal in a resource block. According to an embodiment of the disclosure, the first channel estimation value may refer to a channel estimation value having the lowest mean squared error (MSE) among channel estimation values based on DM-RSs in multiple resource blocks, according to a determination of an RS-based channel selector included in the receiver. For example, the first channel estimation value may refer to a representative channel estimation value determined based on all DM-RSs in the resource block. Specifically, the first channel estimation value may correspond to a channel estimation value derived by the receiver by using an RS-based representative channel estimator (215 of FIG. 2). In addition, the first channel estimation value, which is a representative channel estimation value, may be determined based on correlation information on time and frequency of a channel of a resource element to which a DM-RS is applied in the resource block. In this case, the resource block may refer to a resource in a MIMO-OFDM network to which code division multiplexing is applied.

In operation 620, the receiver may determine a first data symbol of the resource block, based on the first channel estimation value determined in operation 610. In this case, the first data symbol may be transmitted through resource elements in which DM-RSs are not transmitted among resource elements in the resource block.

According to an embodiment of the disclosure, after detecting the first data symbol, the receiver may additionally perform channel decoding, based on the detected data symbol, and regenerate data symbols, based on a result of the channel decoding. The regenerated data symbols may be used when the receiver determines whether to derive a channel estimation value based on DM-RSs.

In operation 630, the receiver may determine whether to obtain a second channel estimation value based on the detected data symbol. The second channel estimation value may refer to a channel estimation value derived based on data symbols. For example, the second channel estimation value may refer to a value obtained by estimating a channel by a DS-based channel estimator included in the receiver of FIG. 2 by using the detected data symbol. According to an embodiment of the disclosure, the receiver may determine whether to update the first channel estimation value determined based on the data symbol detected in operation 620 to the second channel estimation value.

When the receiver determines not to determine the second channel estimation value, the receiver may perform decoding on data symbols of the resource block, based on the data symbol detected based on the first channel estimation value. On the other hand, when the receiver determines to determine the second channel estimation value, the receiver may determine the second channel estimation value according to the following operations.

According to an embodiment of the disclosure, the operation in which the receiver determines to determine the second channel estimation value based on the detected data symbol may correspond to an operation in which the DS-based channel estimation controller included in the receiver of FIG. 2 determines whether to activate the DS-based channel estimator. For example, in the operation of determining whether to obtain the second channel estimation value, the receiver may compare a mean squared error (MSE) of the first channel estimation value with an MSE of the second channel estimation value, and determine to determine the second channel estimation value when the MSE of the second channel estimation value is lower than the MSE of the first channel estimation value.

According to an embodiment of the disclosure, when the receiver determines to determine the second channel estimation value, the receiver may determine a sub-block into which a resource block is to be divided, divide the resource block according to a determined sub-block size, and determine the second channel estimation value, based on data symbols included in resource elements in the sub-block. Meanwhile, the size of the sub-block may be determined by using a predetermined sub-block size or by calculating a sub-block size that minimizes the MSE of the second channel estimation value. On the other hand, when the receiver determines not to determine the second channel estimation value, the receiver may omit the operations of determining the sub-block and the second channel estimation value, and may perform channel decoding, based on the data symbol detected in operation 620.

In operation 640, when the receiver determines to determine the second channel estimation value, the receiver may re-detect data symbols, based on the second channel estimation value. For example, when the DS-based channel estimator included in the receiver determines a channel estimation value based on the detected data symbol, a data symbol detector included in the receiver may re-detect data symbols, based on the channel estimation value estimated by the DS-based channel estimator. In this case, the re-detected data symbol may be referred to as a second data symbol.

In operation 650, the receiver may perform channel decoding, based on the data symbol re-detected by using the second channel estimation value in operation 640. For example, a channel decoder in the receiver may recover and obtain information bits for the corresponding resource block, based on the re-detected data symbols.

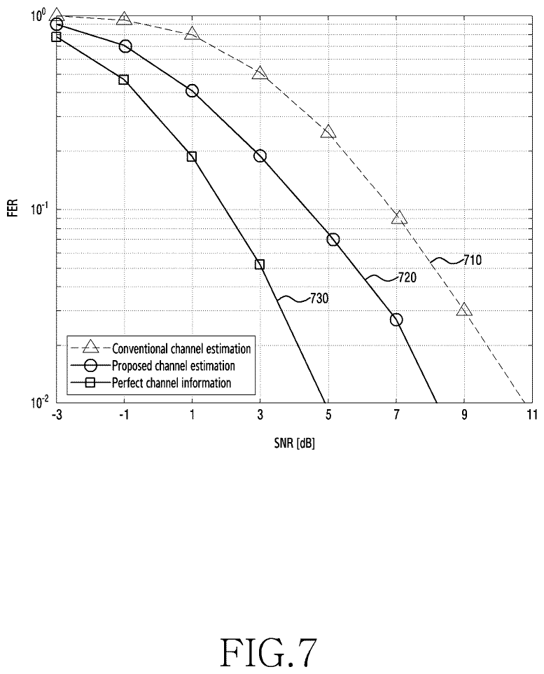

FIG. 7 illustrates a frame error rate (FER) versus a signal-to-noise ratio (SNR) according to an embodiment of the disclosure. FIG. 7 assumes a scenario where there are 2 transmission antenna ports and 4 antenna ports. In addition, FIG. 7 assumes a 4-quadrature amplitude modulation (QAM) scenario where a resource block includes 12 subcarriers and 14 OFDM symbols, and one CDM group exists, and assumes that 6 DM-RSs are transmitted in each of a third OFDM symbol and a 12th OFDM symbol in the resource block. In this case, channel estimation based on DM-RSs and data symbols uses a least squares technique, and data symbol detection uses a linear minimum mean square error method. In addition, a channel varies over time according to [Equation 14] below.

$$H [ n , k ] = ϵ H [ n - 1 , k ] + \sqrt{1 - {ϵ}^{2}} Z [ n , k ] \qquad [ Equation 14 ]$$

In Equation 14, ∈ represents a time domain correlation coefficient with a previous channel, and Z[n, k] denotes a complex Gaussian random matrix having the same variance as the channel. In FIG. 7, ∈=0.9924 is assumed. If a carrier frequency is 3.5 GHz and an OFDM symbol period is 71.35 μs, the time domain correlation coefficient with the previous channel may correspond to a case in which the speed of a receiver is 120 km/h.

A conventional channel estimation simulation result 710 of FIG. 7 illustrates a result of a frame error rate versus a signal-to-noise ratio when a conventional channel estimation method using a DM-RS is employed. A conventional method for estimating a channel by using a DM-RS may refer to a method for dividing DM-RSs into CDM groups, and deriving a channel estimation value for each CDM group to estimate a channel. For example, this may refer to a method for deriving a channel estimation value by using an RS group-based channel estimator of FIG. 2 (210 of FIG. 2). However, the conventional channel estimation simulation result 710 may be a channel estimation simulation result considering only a method for estimating a channel by using a DM-RS, and not considering a method for estimating a channel based on a data symbol.

A proposed channel estimation simulation result 720 illustrates a simulation result obtained when a channel estimation value is derived based on DM-RSs, data are detected based on the derived channel estimation value, and a channel is estimated based on the detected data symbols. For example, the proposed channel estimation simulation result 720 may be a simulation result obtained by estimating a channel by deriving a channel estimation value representative of all DM-RSs by using an RS-based representative channel estimator of FIG. 2, detecting data symbols based on the derived channel estimation value, and re-detecting data symbols by deriving a channel estimation value based on the detected data symbols. A perfect channel information simulation result 730 illustrates a result of a frame error rate versus a signal-to-noise ratio when channel information is almost identical to actual channel information.

Referring to FIG. 7, the proposed channel estimation simulation result 720 exhibits a tendency closer to the perfect channel information simulation result 730 than the conventional channel estimation simulation result 710. That is, the proposed channel estimation simulation result 720 may indicate that a lower frame error rate may be achieved than the conventional channel estimation simulation result 710 in an environment where a channel varies over time.

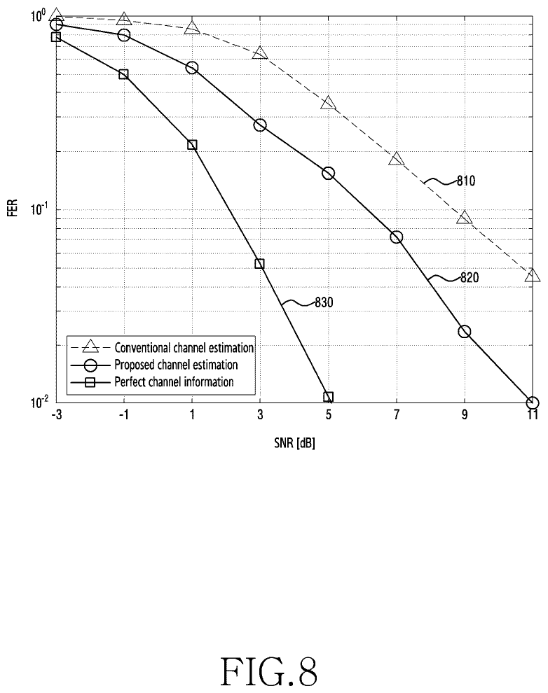

FIG. 8 illustrates a frame error rate versus a signal-to-noise ratio according to an embodiment of the disclosure. FIG. 8 assumes a scenario where there are 2 transmission antenna ports and 4 antenna ports, and assumes a 4-QAM scenario where a resource block includes 12 subcarriers and 14 OFDM symbols, and one CDM group exists. However, FIG. 8 assumes that only six DM-RSs are transmitted only in a third OFDM symbol in a resource block, and does not assume a scenario in which DM-RSs are transmitted in a 12th OFDM symbol as in FIG. 7. channel estimation based on DM-RSs and data symbols uses a least squares technique, and data symbol detection uses a linear minimum mean square error method. In addition, a channel varies over time according to [Equation 14] described with reference to FIG. 7. In FIG. 8, ∈=0.9924 is assumed in Equation 14. If a carrier frequency is 3.5 GHz and an OFDM symbol period is 71.35 μs, a time domain correlation coefficient with a previous channel may correspond to a case in which the speed of a receiver is 120 km/h.

A conventional channel estimation simulation result 810 of FIG. 8 illustrates a result of a frame error rate versus a signal-to-noise ratio when a conventional channel estimation method using a DM-RS is employed. A conventional method for estimating a channel by using a DM-RS may refer to a method for dividing DM-RSs into CDM groups, and deriving a channel estimation value for each CDM group to estimate a channel. For example, this may refer to a method for deriving a channel estimation value by using an RS group-based channel estimator of FIG. 2 (e.g., 210 of FIG. 2). However, the conventional channel estimation simulation result 810 may be a channel estimation simulation result considering only a method for estimating a channel by using a DM-RS, and not considering a method for estimating a channel based on a data symbol.

A proposed channel estimation simulation result 820 illustrates a simulation result obtained when a channel estimation value is derived based on DM-RSs, data are detected based on the derived channel estimation value, and a channel is estimated based on the detected data symbols. For example, the proposed channel estimation simulation result 820 may be a simulation result obtained by estimating a channel by deriving a channel estimation value representative of all DM-RSs by using an RS-based representative channel estimator of FIG. 2, detecting data symbols based on the derived channel estimation value, and re-detecting data symbols by deriving a channel estimation value based on the detected data symbols. A perfect channel information simulation result 830 illustrates a result of a frame error rate versus a signal-to-noise ratio when channel information is almost identical to actual channel information.

Referring to FIG. 8, the proposed channel estimation simulation result 820 exhibits a tendency closer to the perfect channel information simulation result 830 than the conventional channel estimation simulation result 810. That is, the proposed channel estimation simulation result 820 may indicate that a lower frame error rate may be achieved than the conventional channel estimation simulation result 810 in an environment where a channel varies over time.

Accordingly, it may be seen that, when a channel of a received signal is estimated by determining a representative channel estimation value considering all DM-RSs according to the proposed channel estimation method, and then detecting data symbols by using the representative channel estimation value, and determining a channel estimation value based on the detected data symbols, the estimated channel exhibits a tendency closer to actual channel information than a method for estimating a channel merely based on a channel estimation value derived by considering DM-RSs for each CDM group of the DM-RSs.

The embodiments of the disclosure described and shown in the specification and the drawings are merely particular examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

As described above, a method performed by a receiver in a wireless communication system, according to one or more embodiments of the present disclosure, may include determining a first channel estimation value, based on a demodulation reference signal (DM-RS) symbol in a resource block, detecting a first data symbol, based on the first channel estimation value, determining whether to obtain a second channel estimation value based on the first data symbol, in a case of determining to determine the second channel estimation value, detecting a second data symbol, based on the second channel estimation value, and performing channel decoding on the second data symbol.

According to one or more embodiments of the present disclosure, the first channel estimation value may refer to a representative channel estimation value determined based on all DM-RS symbols in the resource block.

According to one or more embodiments of the present disclosure, the determining of the first channel estimation value may further include determining, as the first channel estimation value, a channel estimation value indicating a lowest mean squared error (MSE) among channel estimation values based on multiple DM-RS symbols in the resource block.

According to one or more embodiments of the present disclosure, the determining of whether to determine the second channel estimation value may further include comparing a mean squared error (MSE) of the first channel estimation value and an MSE of the second channel estimation value, and when the MSE of the second channel estimation value is lower than the MSE of the first channel estimation value, determining to determine the second channel estimation value.

According to one or more embodiments of the present disclosure, the method may further include, in a case of determining to determine the second channel estimation value, determining a size of a sub-block for the resource block, dividing the resource block into multiple sub-blocks according to the size of the sub-block, and determining, for the multiple sub-blocks, estimation values based on a data symbol included in a resource element as the second channel estimation value.

According to one or more embodiments of the present disclosure, the size of the sub-block may be determined by using a predetermined sub-block size or by calculating a sub-block size that minimizes the MSE of the second channel estimation value.

According to one or more embodiments of the present disclosure, the method may include, in a case of determining not to determine the second channel estimation value, performing channel decoding on the first data symbol.

According to one or more embodiments of the present disclosure, the method may further include performing channel decoding on the first data symbol, and regenerating a third data symbol, based on a result of the channel decoding for the first data symbol, wherein the third data symbol is used to determine whether to obtain the second channel estimation value.

According to one or more embodiments of the present disclosure, the first channel estimation value may be determined based on correlation information on time and frequency of a channel of a resource element in which the DM-RS symbol is received in the resource block.

According to one or more embodiments of the present disclosure, the resource block may include a decoding unit of a radio resource for multiple input multiple output (MIMO) orthogonal frequency division multiplexing (OFDM) to which code division multiplexing (CDM) is applied.

As described above, a receiver in a wireless communication system, according to one or more embodiments of the present disclosure, may include at least one processor, wherein the at least one processor is configured to determine a first channel estimation value, based on a demodulation reference signal (DM-RS) symbol in a resource block, detect a first data symbol, based on the first channel estimation value, determine whether to obtain a second channel estimation value based on the first data symbol, in a case of determining to determine the second channel estimation value, detect a second data symbol, based on the second channel estimation value, and perform channel decoding on the second data symbol.

According to one or more embodiments of the present disclosure, the first channel estimation value may refer to a representative channel estimation value determined based on all DM-RS symbols in the resource block.

According to various embodiments of the disclosure, the at least one processor may be configured to determine, as the first channel estimation value, a channel estimation value indicating a lowest mean squared error (MSE) among channel estimation values based on multiple DM-RS symbols in the resource block.

According to one or more embodiments of the present disclosure, the at least one processor may be configured to compare a mean squared error (MSE) of the first channel estimation value and an MSE of the second channel estimation value, and when the MSE of the second channel estimation value is lower than the MSE of the first channel estimation value, determine to determine the second channel estimation value.

According to one or more embodiments of the present disclosure, the at least one processor may be configured to determine a size of a sub-block for the resource block, divide the resource block into multiple sub-blocks according to the size of the sub-block, and determine, for the multiple sub-blocks, channel estimation values based on a data symbol included in a resource element as the second channel estimation value.

According to one or more embodiments of the present disclosure, the size of the sub-block may be determined by using a predetermined sub-block size or by calculating a sub-block size that minimizes the MSE of the second channel estimation value.

According to one or more embodiments of the present disclosure, the at least one processor may be configured to, in a case of determining not to determine the second channel estimation value, perform channel decoding on the first data symbol.

According to one or more embodiments of the present disclosure, the at least one processor may be configured to perform channel decoding on the first data symbol, and regenerate a third data symbol, based on a result of the channel decoding for the first data symbol, wherein the third data symbol is used to determine whether to obtain the second channel estimation value.

According to one or more embodiments of the present disclosure, the first channel estimation value may be determined based on correlation information on time and frequency of a channel of a resource element in which the DM-RS symbol is received in the resource block.

According to one or more embodiments of the present disclosure, the resource block may include a decoding unit of a radio resource for multiple input multiple output (MIMO) orthogonal frequency division multiplexing (OFDM) to which code division multiplexing (CDM) is applied.

What is claimed is:

1. A method performed by a receiver in a wireless communication system, the method comprising:
determining a first channel estimation value, based on a demodulation reference signal (DM-RS) symbol in a resource block;
detecting a first data symbol, based on the first channel estimation value;
determining whether to obtain a second channel estimation value, based on the first data symbol;
in a case that the second channel estimation value is obtained, detecting a second data symbol, based on the second channel estimation value; and
performing channel decoding on the second data symbol.

2. The method of claim 1, wherein the first channel estimation value refers to a representative channel estimation value determined based on all DM-RS symbols in the resource block.

3. The method of claim 1, wherein the determining of the first channel estimation value further comprises determining, as the first channel estimation value, a channel estimation value showing a lowest mean squared error (MSE) among channel estimation values based on multiple DM-RS symbols in the resource block.

4. The method of claim 1, wherein the determining whether to obtain the second channel estimation value further comprises:
comparing a mean squared error (MSE) of the first channel estimation value with an MSE of the second channel estimation value; and
in a case that the MSE of the second channel estimation value is lower than the MSE of the first channel estimation value, determining to determine the second channel estimation value.

5. The method of claim 4, wherein, in the case that the second channel estimation value is obtained, the method further comprises:
determining a size of a sub-block for the resource block;
dividing the resource block into multiple sub-blocks according to the size of the sub-block; and
determining, for the multiple sub-blocks, channel estimation values based on a data symbol in a resource element as the second channel estimation value.

6. The method of claim 1, further comprising:
performing channel decoding on the first data symbol; and
regenerating a third data symbol, based on a result of the channel decoding on the first data symbol,
wherein the third data symbol is used to determine whether to obtain the second channel estimation value.

7. A receiver in a wireless communication system, the receiver comprising at least one processor configured to:
determine a first channel estimation value, based on a demodulation reference signal (DM-RS) symbol in a resource block;
detect a first data symbol, based on the first channel estimation value;
determine whether to obtain a second channel estimation value, based on the first data symbol;
in a case that the second channel estimation value is obtained, detect a second data symbol, based on the second channel estimation value; and
perform channel decoding on the second data symbol.

8. The receiver of claim 7, wherein the first channel estimation value refers to a representative channel estimation value determined based on all DM-RS symbols in the resource block.

9. The receiver of claim 7, wherein the at least one processor is further configured to determine, as the first channel estimation value, a channel estimation value showing a lowest mean squared error (MSE) among channel estimation values based on multiple DM-RS symbols in the resource block.

10. The receiver of claim 7, wherein the at least one processor is further configured to:
compare a mean squared error (MSE) of the first channel estimation value with an MSE of the second channel estimation value; and
in a case that the MSE of the second channel estimation value is lower than the MSE of the first channel estimation value, determine to determine the second channel estimation value.

11. The receiver of claim 10, wherein the at least one processor is further configured to:
determine a size of a sub-block for the resource block;
divide the resource block into multiple sub-blocks according to the size of the sub-block; and
determine, for the multiple sub-blocks, channel estimation values based on a data symbol included in a resource element as the second channel estimation value.

12. The receiver of claim 11, wherein the size of the sub-block is determined by using a predetermined sub-block size or by calculating a sub-block size that minimizes the MSE of the second channel estimation value.

13. The receiver of claim 7, wherein the at least one processor is further configured to, in a case of determining not to obtain the second channel estimation value, perform channel decoding on the first data symbol.

14. The receiver of claim 7, wherein the at least one processor is further configured to:
perform channel decoding on the first data symbol; and
regenerate a third data symbol, based on a result of the channel decoding on the first data symbol, and
wherein the third data symbol is used to determine whether to obtain the second channel estimation value.

15. The receiver of claim 7, wherein the first channel estimation value is determined based on information on time and frequency correlations between channels of a resource element in which the DM-RS symbol is received in the resource block.
